(19) United States
(12) Patent Application Publication
(10) Pub. No.: US 2007/0100674 A1
(43) Pub. Date: May 3, 2007

(54) Device, method and computer program product for determining an importance of multiple business entities

(75) Inventors: Amit Fisher, Nesher (IL); Dagan Gilat, Haifa (IL); Segev Eliezer Wasserkrug, Haifa (IL)

Correspondence Address: Stephen C. Kaufman;IBM CORPORATION, Intellectual Property Law Dept., P.O. Box 218, Yorktown Heights, NY, 10598, US

(73) Assignee: International Business Machines Corporation, Armonk, NY (US)

(21) Appl. No.: 11/243,040

(22) Filed: Oct. 4, 2005

(51) Int. Cl. G06F 17/50

(52) U.S. Cl. 705/7

(57) ABSTRACT

A method for calculating an importance of multiple business entities, the method includes receiving dependency information representative of dependencies between multiple business entities; and utilizing a probability based mathematical model of a business infrastructure for determining the importance of multiple business entities. A device that includes a memory element adapted to receive dependency information representative of dependencies between multiple business entities that form a multi-level business infrastructure; and to receive additional information representative of at least one characteristic of at least two business entities that belong to the multi-level business infrastructure; and a processor, connected to the memory element, the processor is adapted to calculate, in response to the received information, an importance of each of the multiple business entities; whereas an importance of a business entity represents a product resulting from utilizing the business entity.

### FIELD OF THE INVENTION

The present invention relates to methods, devices and computer program products that determine the importance of multiple business entities, especially in a complex multiple-level environment.

### BACKGROUND OF THE INVENTION

The infrastructure of modern organizations can include a large number of business entities. These entities can include tangible entities as well as intangible entities. The tangible entities can include IT entities but this is not necessarily so. Typically, the different entities are arranged in multiple levels, starting from a business-level business entities such as business processes, intermediate level business entities such as activity business entities, and lower level business entities such as hardware business entities.

An importance of a business entity can affect various decisions including business entity upgrading or replacement, failure analysis, outsourcing analysis, strategic investments, capital and cost allocations and the like.

Determining an importance of a business entity can be very problematic, especially when the business entity is a part of a complex multiple level infrastructure. The importance of a certain business entity can be responsive to the relationship between that business entity and other business entities. In a complex infrastructure the number of connections between business entities can be very large thus dramatically complicating the importance determination process and even preventing such a calculation to be successfully completed.

In addition, the importance of various business entities, especially the intermediate level business entities and the low level business entities, is neither provided nor can be easily evaluated. These business entities are usually described in terms that do not reveal their importance.

There is a need to provide methods, systems and computer readable products that can determine the importance of multiple business entities, especially in a complex multiple-level environment.

### SUMMARY OF THE PRESENT INVENTION

A method for calculating an importance of multiple business entities, the method includes receiving dependency information representative of dependencies between multiple business entities; and utilizing a probability based mathematical model of a business infrastructure for determining the importance of multiple business entities.

Conveniently, the method includes generating the probability based mathematical model.

Conveniently, the stage of generating includes calculating inter-entity importance related probabilities.

Conveniently, the stage of utilizing comprises utilizing intrinsic probabilities.

Conveniently, the importance of a business entity represents a benefit resulting from a replacement or an update of the business entity.

Conveniently, the determining of an importance of a first business entity includes multiplying an intrinsic importance of a dependency related business entity by an indication of an influence of a change in the dependency related business entity on the first business entity.

Conveniently, the method further includes selecting between multiple importance calculation mechanisms.

A method for calculating an importance of multiple business entities, the method includes: receiving dependency information representative of dependencies between business entities of a multi-level business infrastructure; receiving a first type of information representing a characteristic of high level business entities; converting the first type of information to importance information of the high level business entities; and calculating an importance of intermediate level and low level business entities in response to the importance information of the high level business entities.

A device that includes a memory element adapted to receive dependency information representative of dependencies between multiple business entities that form a multi-level business infrastructure; and to receive additional information representative of at least one characteristic of at least two business entities that belong to the multi-level business infrastructure; and a processor, connected to the memory element, the processor is adapted to calculate, in response to the received information, an importance of each of the multiple business entities; whereas an importance of a business entity represents a product resulting from utilizing the business entity.

A computer program product that includes a computer useable medium including a computer readable program, wherein the computer readable program when executed on a computer causes the computer to: receive dependency information representative of dependencies between multiple business entities; and to utilize a probability based mathematical model of a business infrastructure for determining the importance of multiple business entities.

A computer program product that includes a computer useable medium including a computer readable program, wherein the computer readable program when executed on a computer causes the computer to: receive dependency information representative of dependencies between business entities of a multi-level business infrastructure; receive a first type of information representing a characteristic of high level business entities; convert the first type of information to importance information of the high level business entities; and calculate an importance of intermediate level and low level business entities in response to the importance information of the high level business entities.

### BRIEF DESCRIPTION OF THE DRAWINGS

The present invention will be understood and appreciated more fully from the following detailed description taken in conjunction with the drawings in which:

FIG. 1 illustrates a method for determining the importance of multiple business entities, according to an embodiment of the invention;

FIG. 2 illustrates method for calculating an importance of multiple business entities, according to an embodiment of the invention;

FIG. 3 illustrates a method for determining the importance of an business entity, according to an embodiment of the invention;

FIG. 4 illustrates an exemplary high level business entity dependency graph;

FIG. 5 illustrates an exemplary multi-level dependencies graph;

FIG. 6 illustrates a business importance graph, according to an embodiment of the invention;

FIG. 7 illustrates a method for calculating an importance of multiple business entities, according to an embodiment of the invention; and

FIG. 8 illustrates a device, according to an embodiment of the invention.

### DETAILED DESCRIPTION OF THE DRAWINGS

Methods, devices and computer program products are provided. According to an embodiment of the invention the devices, methods and computer program products determine the business importance of business entities that belong to (or even form) a business infrastructure. The business infrastructure usually includes business entities of multiple levels and can accordingly be referred to as a multi-level business infrastructure.

According to one embodiment of the invention the determination is based upon a probability based model of the business infrastructure. The model can be a Bayesian bet but this is not necessarily so. Conveniently, the model is generated by calculating inter-entity importance related probabilities. The importance of a business entity depends upon the inter-entity importance related probabilities and the intrinsic importance of that business entity.

According to another embodiment of the invention the business importance of intermediate level and low level business entities is affected by the importance of high level business entities. Conveniently, received first type of information of high level business entities is converted to importance information of the high level business entities.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

Conveniently, once the importance of an business entity is defined said importance can affect various decisions such as business entity replacements decisions, business entity upgrade decisions, outsourcing decisions, strategic investments, capital and cost allocations and problem resolution decisions. For example: investing in the resiliency of more important business entities, upgrading more important business entities, focusing an infrastructure monitoring process on more important business entities.

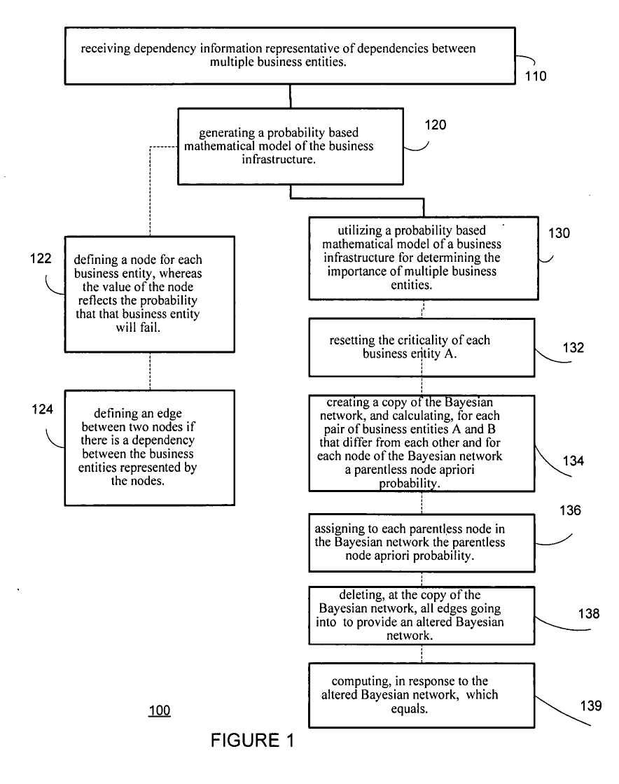

FIG. 1 illustrates a method 100 for determining the importance of multiple business entities, according to an embodiment of the invention.

For convenience of explanation the following description refers to an importance of a business entity as reflecting an impact of a failure of that business entity on other business entities. Accordingly the importance is referred to as criticality.

Those of skill in the art will appreciate that the importance of an business entity can provide indications that differ from the mentioned above indication. For example, the importance can represent a product (such as but not limited to revenue) resulting from a utilization of a business entity. Alternatively or additionally, a business entity can be assigned with different importance values, representative of different indications.

Method 100 is explained by referring to a Bayesian network. It is noted that other probability based mathematical models can be used within the scope of the invention.

Conveniently, the following assumptions are made and the following definitions are used. It is noted that at least some of the assumptions are optional and provided for clarity of explanation.

C(A) is the criticality of business entity A, IC(A) is the inherent criticality of business entity A. The inherent criticality is a measure of the importance of business entity A regardless the dependency between business entity A and other business entities. Typically, the inherent criticality of a hardware or software business entity is zero as such a business entity is not expected to have any inherent business importance, and its importance results from business processes which depend on it.

Conveniently, if the failure of business entity A always causes business entity B to fail, then C(A)−IC(A)≧C(B).

Conveniently, if E_{A} is the set of business entities that fail as a result of the failure of business entity A (excluding A). Accordingly, if E_{A}⊂E_{B} [symbol] C(A)−IC(A)≦C(B)−IC(B).

Conveniently, if E is the set of all business entities in the business infrastructure, and EP_{A} is the set of all business entities which depend on A, then C(A) on the whole business infrastructure is the same as C(A) on EP_{A}.

For each DεEP_{B}, C(B)∝IC(D). In other words, if the inherent criticality of business entity D increases, then the criticality of business entity B increases. This proportion reflects the likelihood that the failure of business entity B will cause the failure of business entity D.

The notation F_{A} for any business entity A is used to denote the probabilistic event that business entity A failed.

The criticality of a business entity can be calculated in various manners, thus one out of multiple importance calculation mechanisms can be selected. Each importance calculation mechanism uses a different probabilistic space and involves calculating the inter-entity importance probability in a different manner. The selection can be responsive to the ability to implement the various calculation mechanisms.

Three exemplary importance calculation mechanisms as well as three different inter-entity importance probabilities are illustrated below.

According to an embodiment the importance of business entity B is calculated by the following equation:

$$C ( B ) = {\sum }_{A \neq B} ( Pr ( {F}_{A} \vert {F}_{B} ) - Pr ( {F}_{A} \vert ⫬ {F}_{B} ) ) \cdot IC ( A ) + IC ( B ) .$$

In this case, the criticality of business entity B equals the inherent criticality of business entity B (IC(B)) plus the sum (over all business entities excluding business entity B) of products of (i) the inherent criticality of A (IC(A)) and (ii) an increase in likelihood that business entity A will fail if the state of business entitles A and B changes from a functional business entity B to a failed business entity B.

According to another embodiment the importance of business entity B is calculated by the following equation

$$C ( B ) = {\sum }_{A} ( Pr ( {F}_{A} \vert do ( {F}_{B} ) ) - Pr ( {F}_{A} \vert do ( ⫬ {F}_{B} ) ) \cdot IC ( A ) + IC ( B ) .$$

The notation do(F_{B}) represents that entity B failed for a reason “outside” or the original probability space (i.e. it was set to fail).

In this case, the criticality of business entity B equals the inherent criticality of business entity B (IC(B)) plus the sum (over all business entities excluding business entity B) of products of (i) the inherent criticality of A (IC(A)) by (ii) the difference between the probability that business entity A failed if business entity B has independently failed or did not independently fail.

According to another embodiment the importance of business entity B is calculated by the following equation:

$$C ( B ) = {\sum }_{A} Pr ( {F}_{{A}_{{F}_{B}}} \vert ⫬ {F}_{A} , ⫬ {F}_{B} ) \cdot IC ( A ) + IC ( B ) ,$$

whereas

$$Pr ( {F}_{{A}_{{F}_{B}}} \vert ⫬ {F}_{A} , ⫬ {F}_{B} )$$

is the probability that business entity A fails given that business entity B is set to fail, and given that previously both business entities A and B were functional. In other words, given an initial state in which business entities A and B are functional, what is the probability that business entity A fails if business entity B has independently failed.

$$Pr ( {F}_{{A}_{{F}_{B}}} \vert ⫬ {F}_{A} , ⫬ {F}_{B} )$$

is also denoted PS(F_{A}→F_{B}). Thus the following equation has the following form:

$$C ( B ) = {\sum }_{A} PS ( {F}_{A} \to {F}_{B} ) \cdot IC ( A ) + IC ( B ) .$$

According to an embodiment the importance of business entity B is calculated by the following equation:

$$C ( B ) = {\sum }_{A} Pr ( {F}_{A} \vert do ( {F}_{B} ) , do ( {F}_{{S}_{AB}} ) ) \cdot IC ( A ) + IC ( B ) ,$$

where Pr(F_{A}|do(F_{B}),do(F_{S}_{_{AB}})) illustrates the direct effect of an independent failure of business entity B on business entity A.

It is further assumed that the business entities can include tangible business entities such as applications and resources, and intangible business entities such as business processes and activities.

Conveniently, the dependencies between business entities can include mandatory dependencies, compound dependencies, alternate dependency, and workflow dependencies.

Business entity A has a mandatory dependency on a set of business entities B1, . . . , Bn with a constant c (mandatory dependency value) if the failure of any of the business entities B1, . . . , Bn causes business entity A to fail with likelihood c.

A Compound dependency includes a combination of two or more different dependencies.

Business entity A has an alternating dependency, such as a “m out of n” dependency, on a set of business entities B1, . . . , Bn with a constant c if the failure of m business entities out of business entities B1, . . . , Bn causes business entity A to fail with likelihood c.

Workflow dependencies are defined between activity business entities. Conveniently, these dependencies include Next, XOR Split, AND Split, XOR join, AND join. A workflow dependency may also have a constant c associated with it. Next illustrates a sequential relationship between two business entities.

Conveniently, there are no dependencies between two activities, and an activity cannot depend on a business process. Conveniently, there are no cycles in the dependency diagrams.

Conveniently, for each business process, a workflow corresponding to this business process is specified in a dependency diagram that is provided as an input to method 100.

It is noted that a source of uncertainty for mandatory dependencies between activities and business processes stems from the fact that a specific activity does not necessarily have to participate in every instance of a business process. Therefore, this uncertainty has to be consistent with the workflow definition of the business process.

Conveniently, a logical business entity, such as an activity or business process cannot fail if none of the business entities on which it depends fail. For example, if an activity uses several applications to carry out its task, and all of the applications function correctly, than the activity will not fail. This rationale behind this assumption is, that in order for a process or activity to fail, an event (bug, disk crash, etc.) must occur in some tangible business entity, such as code or hardware.

Conveniently, if c is the certainty of a mandatory dependency between a business process B and a set of activities A₁, . . . , Aₙ then c is the likelihood that if any one of activities A₁, . . . , Aₙ fails, then so will process B.

Conveniently, if c is a certainty on an edge belonging to a XOR split pattern from some activity A then c is the likelihood that that edge will be taken when leaving activity A on that workflow process.

Conveniently, a business process can be in one of two states, active or failed. Conveniently, a business process is uniquely identified by a workflow dependency, i.e., a business process is synonymous with a single workflow.

Conveniently, a dependency diagram that is provided to method 100 is fully specified—i.e., all business entities that affect the relevant business processes appear. This ensures, for example, that all outside causes of failure for each business entity appear in the diagram and, also, that if a business process has both a workflow dependency to a set of activities S, and mandatory dependencies to another set of activities S′, then S′⊂S.

Conveniently, the probabilities of an edges that exit a XOR split node should be normalizes. Typically the sum of all these probabilities equals one, but this is not necessarily so. Out_{A} denotes the edges exiting activity A when the exit is of type XOR Split. The certainty on a link eεOut_{A} is defined as the probability that after activity A completes, the link e will be taken. If all of the outgoing links of a business entity have constants c defined, the sum of these certainties will be normalized to one, by dividing each certainty by the sum of the certainties of all outgoing links. If some of the outgoing links of a business entity have constants c and some do not, and the defined constants sum to less than one, than the remaining probability will be divided equally between the outgoing links that do not have certainties defined. The case in which the constants defined sum to more than one will be invalid, and the certainties will have to be redefined. If none of the outgoing links of an activity have certainties defined, then the probability of taking any link will be

$$\frac{1}{\vert {Out}_{A} \vert}$$

(A link is chosen at random with equal probability).

Method 100 starts by stage 110 of receiving dependency information representative of dependencies between multiple business entities. Conveniently, the dependency information includes a dependency diagram.

Stage 110 also includes receiving the inherent criticality of each business entity and an independent failure probability of each business entity. Conveniently, stage 110 includes receiving a dependency diagram. The independent failure probability of a business entity reflects the probability that the business entity will fail, if the business entity does not depend on other business entities or reflects the probability that this business entity will fail given that other business entities (or business entity) on which the certain business entity depends did not fail.

Stage 110 is followed by stage 120 of generating a probability based mathematical model of the business infrastructure. Conveniently, stage 120 includes calculating inter-entity importance related probabilities.

Conveniently, stage 120 includes generating a Bayesian network representative of the business infrastructure in response to the information received during stage 110.

Bayesian networks are probabilistic directed graphical models in which nodes represent random variables, and edges between nodes represent conditional independence assumptions. An edge (or arc) between a first node to a second node indicates that an event represented by the first node causes an event that is represented by the second node. Bayesian Networks are also known as Belief Networks.

Conveniently, stage 120 includes stages 122-124. Stage 122 includes defining a node for each business entity, whereas the value of the node reflects the probability that that business entity will fail.

Conveniently, stage 122 includes defining, for each tangible business entity that depend upon one or more other business entities, an independent failure node that represents a probability of a independent failure of that business entity—the probability that the tangible business entity fails although neither of the business entities upon it depends failed.

Stage 122 is followed by stage 124 of defining an edge between two nodes if there is a dependency between the business entities represented by the nodes.

Stage 120 is followed by stage 130 of utilizing a probability based mathematical model of a business infrastructure for determining the importance of multiple business entities.

Conveniently, stage 130 includes utilizing a Bayesian network to compute inter-entity importance probabilities and determining the importance of multiple business entities. The determination is responsive to the intrinsic criticality of various business entities and inter-entity critically related probabilities.

For example the inter-entity importance probability can be: (i) an increase in likelihood that business entity A will fail if the state of entitles A and B changes from a state in which business entity B is functional to a state in which business entity B fails; (ii) the difference between the probability that business entity A failed if business entity B has independently failed or did not independently fail; (iii) given an initial state in which business entities A and B are functional, the probability that business entity A fails if element B has independently failed; (iv) a direct effect of an independent failure of business entity B on business entity A.

For example, assuming that the criticality is calculated by the following equation:

$$C ( B ) = {\sum }_{A} PS ( {F}_{A} \to {F}_{B} ) \cdot IC ( A ) + IC ( B )$$

then stage 130 includes stages 132-136.

Stage 132 includes resetting the criticality of each business entity A.

Stage 132 is followed by stage 134 of creating a copy of the Bayesian network, and calculating, for each pair of business entities A and B that differ from each other and for each node of the Bayesian network Pr(F| [symbol] F_{A}, [symbol] F_{B}). This probability is referred to as parentless node apriori probability.

Stage 134 is followed by stage 136 of assigning to each parentless node in the Bayesian network the parentless node apriori probability. Stage 136 is followed by stage 138 of deleting, at the copy of the Bayesian network, all edges going into F_{A} to provide an altered Bayesian network.

Stage 138 is followed by stage 139 of computing, in response to the altered Bayesian network, Pr(F_{B}|F_{A}) which equals PS(F_{A}→F_{B}).

Stage 130 conveniently includes defining an inter-entity importance probability Pr(F_{A}|P_{A}) that represents the probability of a failure of a business entity if one or more of its parent business entities fail.

F_{A} is a node in the Bayesian network, and it is true if business entity A failed. It is false elsewhere. P_{A} is the parent business entities of business entity A—the business entities that depend upon business entity A.

If business entity A is “n out of m” dependent upon P_{A} then Pr(F_{A}|P_{A})=1 if at least for n of the nodes FεP_{A}, F=true, and 0 otherwise.

If business entity A is not business process or a business entity which depends on other business entities in an alternate manner, then all of its dependencies are either mandatory or compound and they usually do not have certainty defined on them. Therefore,

$$Pr ( {F}_{A} \vert {P}_{A} ) = \{ \begin{matrix}1 , ∃ F ∈ {P}_{A} s . t . & F = true \\ 0 & otherwise\end{matrix} .$$

If business entity A is a business process and it depends on one or more tangible business entities and the tangible business entities failed then business entity A fails. In mathematical terms—if ∃F_{E}εP_{A} business entity E is not an activity and F_{E}=true [symbol] Pr(F_{A}|P_{A})=1.

If business entity A is a business process and the only dependency between business entity A and activities is a workflow dependency, than Pr(F_{A}|P_{A}) is the probability of reaching any of the failed activities in an instance of the business process, as defined by the probabilities on the workflow dependencies as defined above.

Conveniently, for workflow dependencies other than XOR Split there is no probability defined, and the path is defined by the specific pattern. This is as only a XOR chooses a path—all other workflow dependencies assume that the workflow must proceed on all exiting edges.

Conveniently, if the workflow relationship is a XOR split, the certainties on the edges are normalized to be between 0 and 1 in order to constitute valid probabilities. The normalization process is described in a later subsection.

Conveniently, if in addition to a workflow dependency there are also other mandatory dependencies, the probability will be defined as the maximum of the probabilities of the two cases.

Stage 130 can be further illustrated by the following example. It is assumed that there is a mandatory dependency between business process B and activities A₁ and A₂, that there is a workflow dependency between B and activities A₁,A₂ and A₃. It is further assumed that these dependencies have the following parameters: (a) the certainty of the mandatory dependency between B and A₁ is c₁, (b) the certainty of the mandatory dependency between B and A₂ is c₂, (c) c₃, c₄, c₆, c₇ are smaller than c₁, c₁ is smaller than c₂, and c₂ is smaller than c₈.

The inter-entity importance probabilities defined by the workflow dependencies are: Pr_{WF}(F_{B}|F_{A}_{₁}, [symbol] F_{A}_{₂}, [symbol] F_{A}_{₃})=c₃, Pr_{WF}(F_{B}| [symbol] F_{A}_{₁},F_{A}_{₂}, [symbol] F_{A}_{₃})=c₄, Pr_{WF}(F_{B}| [symbol] F_{A}_{₁}, [symbol] F_{A}_{₂},F_{A}_{₃})=c₅, Pr_{WF}(F_{B}|F_{A}_{₁},F_{A}_{₂}, [symbol] F_{A}_{₃})=c₆, Pr_{WF}(F_{B}|F_{A}_{₁}, [symbol] F_{A}_{₂},F_{A}_{₃})=c₇, Pr_{WF}(F_{B}| [symbol] F_{A}_{₁},F_{A}_{₂},F_{A}_{₃})=c₈, Pr_{WF}(F_{B}|F_{A}_{₁},F_{A}_{₂},F_{A}_{₃})−1, Pr_{WF}(F_{B}| [symbol] F_{A}_{₁}, [symbol] F_{A}_{₂}, [symbol] F_{A}_{₃})=0.

In addition, the probabilities on the Bayesian network will be defined as follows: Pr(F_{B}|F_{A}_{₁}, [symbol] F_{A}_{₂}, [symbol] F_{A}_{₃})=c₁ as c₃<c₁ Pr(F_{B}| [symbol] F_{A}_{₁},F_{A}_{₂}, [symbol] F_{A}_{₃})=c₂ as c₄<c₂ Pr(F_{B}| [symbol] F_{A}_{₁}, [symbol] F_{A}_{₂},F_{A}_{₃})=c₅ as that it the only way that only A₃ influences B. Pr(F_{B}|F_{A}_{₁},F_{A}_{₂}, [symbol] F_{A}_{₃})=c₂ as c₂ is the maximum of c₂,c₁,c₆, which are all the uncertainties of the effects between A₁,A₂,A₃ and B.

Pr(F_{B}|F_{A}_{₁}, [symbol] F_{A}_{₂},F_{A}_{₃})=c₁ as c₁>c₇. Pr(F_{B}| [symbol] F_{A}_{₁},F_{A}_{₂},F_{A}_{₃})=c₈ as c₈>c₂. Pr(F_{B}|F_{A}_{₁},F_{A}_{₂},F_{A}_{₃})=c1 as a business process will always fail if all of the activities on which it depends fail. Pr(F_{B}| [symbol] F_{A}_{₁}, [symbol] F_{A}_{₂}, [symbol] F_{A}_{₃})=0 as a business process will not fail if none of the activities on which it depends fails.

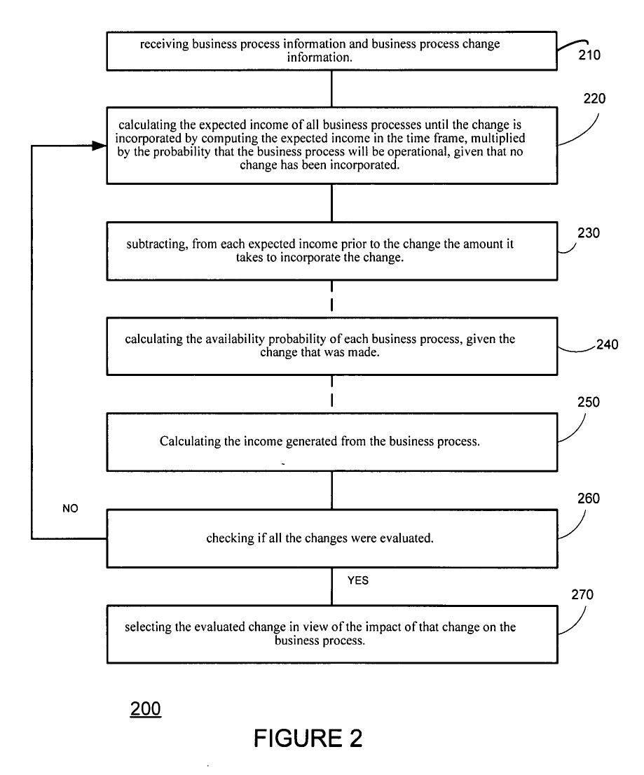

FIG. 2 illustrates method 200 for calculating an importance of multiple business entities, according to an embodiment of the invention.

Method 200 is adapted to evaluate changes to a certain business infrastructure. The importance of certain business entities are evaluated in view of the income that can result from changing the business entities.

Method 200 refers to an annual calculation of revenue, although other time periods can be selected.

Method 200 starts by stage 210 of receiving business process information and business process change information.

The business process information includes an expected income from that business process when it is functional and a time period during which the business process is expected to be operational. The expected income can be defined in various manners including overall income, income per various portion of the time period during which the business is expected to be functional.

The business process change information includes an initial investment in incorporating that change, an annual addition of total cost of ownership (TCO) of that change, and a time it would take to incorporate the change. It is noted that the annual addition of TCO can be expressed in various manners such as annual average amount or different average amounts for different times of the year.

It is noted that the additional TCO can be negative, as some changes may reduce the TCO. Conveniently, for each business entity other then a business process, this algorithm assumes that the inherent criticality is zero.

Stage 210 is followed by stage 220 of calculating the expected income of all business processes until the change is incorporated by computing the expected income in the time frame, multiplied by the probability that the business process will be operational, given that no change has been incorporated.

Stage 220 is followed by stage 230 of subtracting, from each expected income prior to the change the amount it takes to incorporate the change.

Stage 230 is followed by stage 240 of calculating the availability probability of each business process, given the change that was made. Stage 240 can involve utilizing a Bayesian network.

Stage 240 is followed by stage 250 of calculating the income generated from the business process. Stage 250 conveniently includes calculating the income in the remaining time period for that business process, and multiplying it by the new availability probability of the business process.

Stages 220-250 can be repeated for each evaluated change. Thus, stage 250 can be followed by query stage 260 of checking if all the changes were evaluated. If not—stage 260 jumps to stage 220, else it is followed by stage 270 of selecting the evaluated change in view of the impact of that change on the business process. Stage 270 can include selecting the most profitable change, and the like.

Conveniently, stage 270 include storing the income generated by each evaluated change. Stage 270 can also include storing the incomes in an ascending order of time.

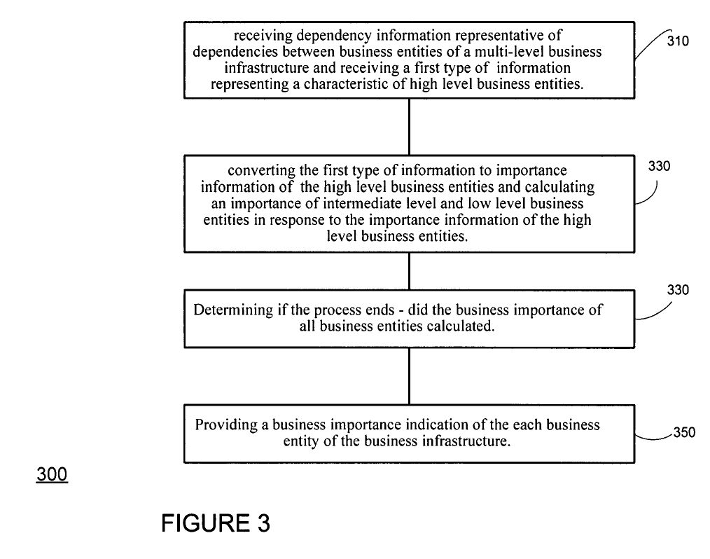

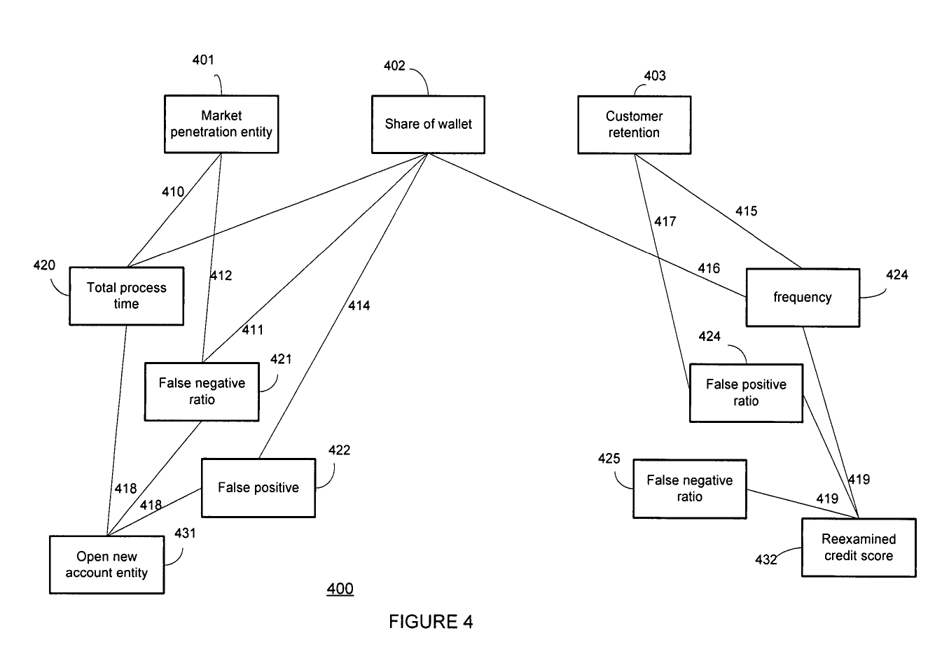

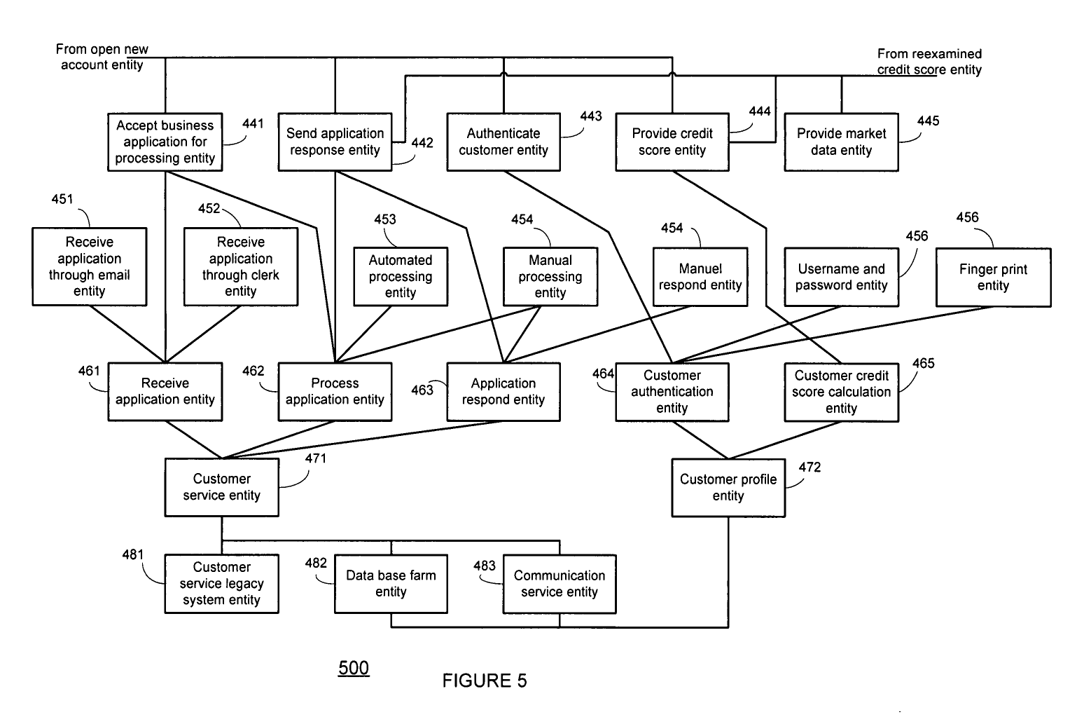

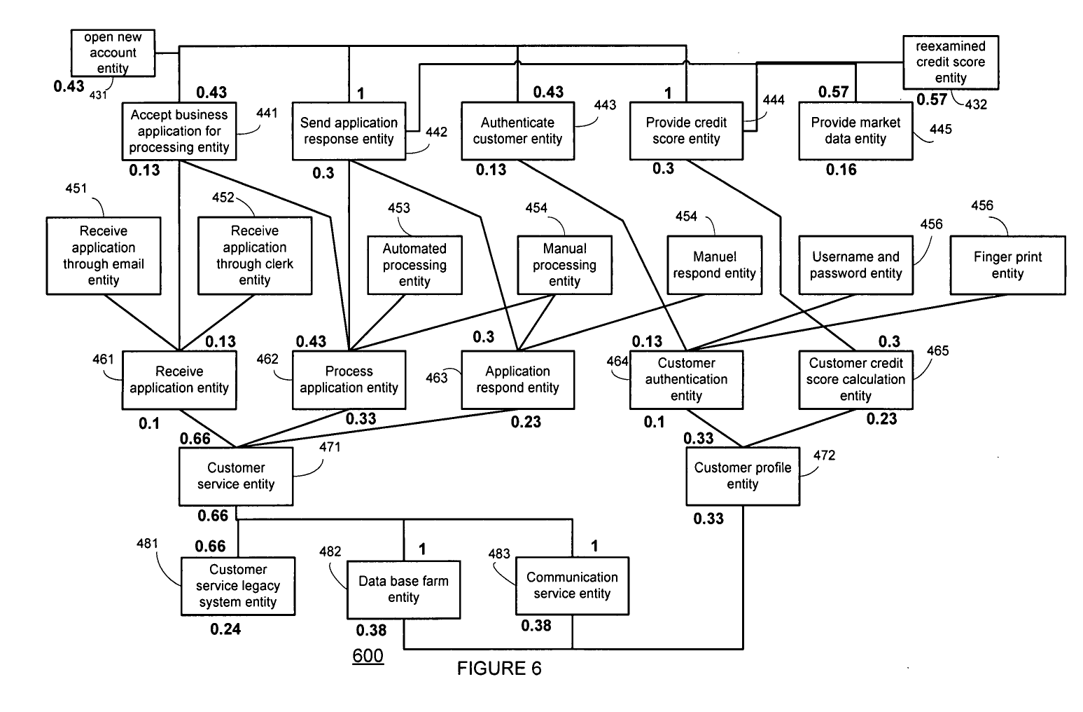

FIG. 3 illustrates a method 300 for determining the importance of an business entity, according to an embodiment of the invention. FIG. 4 illustrates an exemplary high level business entity dependency graph 400 that illustrates the dependency between various high level business entities of a business infrastructure. FIG. 5 illustrates an exemplary multilevel dependencies graph 500 that represents the dependencies between various business entities of the business infrastructure, including medium level business entities and low level business entities. FIG. 6 illustrates a business importance graph 600 that represents the importance of each business entity of the business infrastructure, according to an embodiment of the invention.

For convenience of explanation method 300 is explained by referring to graphs 400-600.

Method 300 starts by stage 310 of receiving dependency information representative of dependencies between business entities of a multi-level business infrastructure and receiving a first type of information representing a characteristic of high level business entities. The first type of information can include high level business entity economical values, operational measurements representing a relationship between changes in various business entities and the like. The first type of information is illustrated by boxes 420-425 and links 411-419 in graph 400.

High level business entity dependency graph 400 illustrates three highest level business entities 401-403, second level business entities 431 and 432 and multiple qualitative measures (also referred to as operational measures) that are associated with the second level business entities and the highest level business entities.

These highest and second level entities can be regarded as high level business entities while other business entities (such as entities 441-473 of graph 600) can be regarded as medium level business entities and low level business entities.

The highest level business entities include market penetration business entity 401, share of wallet business entity 402 and customer penetration business entity 403.

The second level business entities include open new account business entity 431 and reexamined credit score business entity 432.

The multiple operational measurements business entities are associated with the highest level business entities and with the collaboration pattern business entities. They include total process time 420, false negative ratio 421, false positive ratio 422, frequency 423, false negative ratio 424 and false positive ratio 425. These multiple operational measurement business entities can be regarded as business entities.

Total process time 420 is linked by links 410 and 411 to market penetration business entity 401 and to share of wallet business entity 402 accordingly. Link 410 illustrates that a change of 1% in the total process time causes a change of 0.1% in the market penetration business entity 401. Link 411 illustrates that a change of 1% in the total process time causes a change of 0.5% in the share of wallet business entity 402.

False negative ratio 421 is linked by links 412 and 413 to market penetration business entity 401 and to share of wallet business entity 402 accordingly. Link 412 illustrates that a change of 1% in false negative ratio 421 causes a change of 0.2% in the market penetration business entity 401. Link 413 illustrates that a change of 1% in the false negative ratio 421 causes a change of 0.2% in the share of wallet business entity 402.

False positive ratio 422 is linked by link 414 to customer retention business entity 403. Link 414 illustrates that a change of 1% in false positive ratio 422 causes a change of 0.5% in the customer retention business entity 403.

False negative ratio 425 is linked by link 417 to customer retention business entity 403. Link 417 illustrates that a change of 1% in false negative ratio 425 causes a change of 1% in the customer retention business entity 403.

False positive ratio 424 is linked by link 416 to share of wallet business entity 402. Link 416 illustrates that a change of 1% in false positive ratio 424 causes a change of 0.5% in the share of wallet business entity 402.

Frequency 423 is linked by link 415 to customer retention business entity 403. Link 415 illustrates that a change of 1% in frequency 423 causes a change of 0.1% in the customer retention business entity 403.

Each of total process time 420, false negative ratio 421 and false positive ratio 422 is linked by link 418 to the open new account business entity 431. Links 418 illustrates that each of total process time 420, false negative ratio 421 and false positive ratio 422 has the same impact on the open new account business entity 431.

Each of frequency 423, false negative ratio 424 and false positive ratio 425 is linked by link 419 to the reexamined credit score business entity 432. Links 419 illustrates that each of frequency 423, false negative ratio 424 and false positive ratio 425 has the same impact on the reexamined credit score business entity 432.

Multilevel dependencies graph 500 can include the business entities of graph 400, but for simplicity of explanation it will include business entities 431 and 432 and the business entities that have a lower level than business entities 431 and 432.

Open new account business entity 431 depends upon multiple business service business entities such as accept application for processing business entity 441, send application response business entity 442, authenticate customer business entity 443 and provide credit score business entity 444. Reexamined credit score business entity 432 depends upon multiple business service business entities such as send application response business entity 442, provide credit score business entity 444 and provide market data business entity 445.

Accept application for processing business entity 441 depends upon two action business entities—receive application business entity 461 and process application business entity 462. Send application response business entity 442 depends upon two action business entities—application response business entity 463 and process application business entity 462. Authenticate customer business entity 443 depends upon two action business entities—customer authentication business entity 464 and process application business entity 462. Provide credit score business entity 444 depends upon two action business entities—customer credit score calculation business entity 465 and process application business entity 462. Provide market data business entity 445 depends upon a customer profile business entity 472.

Various action business entities 461-465 can include various action implementation business entities 451-457. These entities illustrate that not all entities are required to participate in a business entity importance calculation. Receive application business entity 461 can include a receive application through email business entity 451 and receive application through clerks 452. Process application business entity 462 can include automated processing business entity 453 and manual processing business entity 545. Application respond business entity 463 can include manual processing business entity 454 and manual respond business entity 455. Customer authentication business entity 464 can include username and password business entity 456 and finger print business entity 457.

The action business entities depend upon Business Component business entities. Receive application business entity 461, process application business entity 462 and application respond business entity 463 depend upon customer service business entity 471. Customer authentication business entity 464 and customer credit score calculation business entity 465 depend upon customer profile business entity 472.

The lowest level business entities include a customer service legacy system business entity 481, database farm business entity 482 and communication service business entity 483. Customer service business entity 471 depends on all lowest level business entities 481-483. Customer profile business entity 472 depends upon database farm business entity 482 and communication service business entity 483.

Stage 310 is followed by stage 320 of converting the first type of information to importance information of the high level business entities and calculating an importance of intermediate level and low level business entities in response to the importance information of the high level business entities.

Conveniently stage 320 includes performing business importance calculation of a certain business entity level. Whereas the business importance of a certain business infrastructure entity depends upon the business importance of its direct offspring business entities.

Conveniently, if multiple direct offspring business entity depend upon a certain business entity then the business importance of that certain business entity is the sum of the business importance of all the direct offspring business entities.

Conveniently, stage 320 includes calculating a business importance of certain business entities in response to the economic value of an business entity and the dependencies between business entities.

Assuming that a change of 1% in market penetration business entity equals 3.5 M$, that a change of 1% in the share of wallet business entity 402 equals 5M$ and that a change of 1% in the customer retention business entity 403 equals 1.5M$.

The impact of a change of 1% in the total process time business entity 420 is responsive to these values as well as the relationship between total process time business entity changes and market penetration business entity changes and share of wallet business entity changes, as illustrated by links 410 and 411. Given these values the impact equals 0.1*3.5+0.5*5=2.85.

Accordingly, the impact of a change of 1% in the false negative ratio business entity 421 equals 0.2*3.5+0.2*5=1.7. The impact of a change of 1% in the false positive ratio business entity 422 equals 0.5*5=2.5.

The impact of a change of 1% in the false negative ratio business entity 425 equals 1*6.5=6.5. The impact of a change of 1% in the false positive ratio business entity 424 equals 0.5*5=2.5. The impact of a change of 1% in the frequency business entity 423 equals 0.1*6.5=0.65.

The business value of the open new business entity account represents the impact of a change in 1% in that business entity, and it equals (as indicated by links 418)=(2.85+1.7+2.5)/3=2.35.

The business value of the reexamined credit score business entity 432 represents the impact of a change in 1% in that business entity, and it equals (as indicated by links 419)=(0.65+2.5+6.5)/3=3.13.

Stage 320 is followed by optional stage 330 of normalizing the business model importance of each level.

For example, the business importance of the open new account business entity 431 is normalized to 2.35/(2.35+3.13)=0.43. The business importance of the reexamined new credit score business entity 432 is normalized to 3.13/(2.35+3.13)=0.57.

These normalized business importance values will be used when the business importance of the business service business entity is calculated.

Stage 330 is followed by stage 340 of determining if the process ends—did the business importance of all business entities calculated. If the answer is positive then stage 340 is followed by stage 350 of providing a business importance indication of each business entity of the business infrastructure. Else, stage 340 is followed by stage 320 of processing the business entities of a lower level.

TABLE 1 illustrates the normalized and non-normalized business importance values of the various business entities of graph 600.

TABLE 1

| | | Direct | | |
|---|---|---|---|---|
| | | higher | | |
| | | level | Non- | |
| Business | Business | dependent | normalized | Normalized |
| entity | entity | business | business | business |
| number | level | entities | value | value |
| 441 | Business | 431 | 0.43 | 0.13 |
| | service | | | |
| 442 | Business | 431, | 1 | 0.3 |
| | service | 432 | | |
| 443 | Business | 431 | 0.43 | 0.13 |
| | service | | | |
| 444 | Business | 431, | 1 | 0.3 |
| | service | 432 | | |
| 445 | Business | 432 | 0.57 | 0.16 |
| | service | | | |
| 461 | Action | 441 | 0.13 | 0.1 |
| 462 | Action | 441, | 0.43 | 0.33 |
| | | 442 | | |
| 463 | Action | 442 | 0.3 | 0.23 |
| 464 | Action | 443 | 0.13 | 0.1 |
| 465 | Action | 444 | 0.3 | 0.23 |
| 471 | BC | 461, | 0.66 | 0.66 |
| | | 462, | | |
| | | 463 | | |
| 472 | BC | 464, | 0.33 | 0.33 |
| | | 465 | | |
| 481 | Utility | 471 | 0.66 | 0.24 |
| | technology | | | |
| | component | | | |
| 482 | Utility | 471, | 1 | 0.38 |
| | technology | 472 | | |
| | component | | | |
| 483 | Utility | 471, | 1 | 0.38 |
| | technology | 472 | | |
| | component | | | |

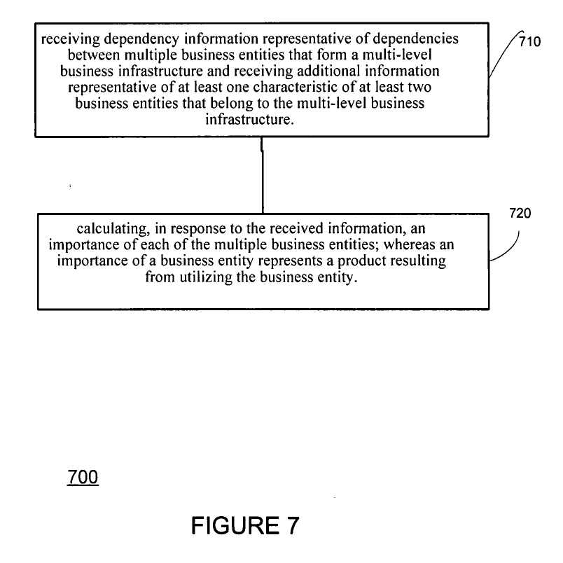

FIG. 7 illustrates a method 700 for calculating an importance of multiple business entities, according to an embodiment of the invention.

Method 700 starts by stage 710 of receiving dependency information representative of dependencies between multiple business entities that form a multi-level business infrastructure and receiving additional information representative of at least one characteristic of at least two business entities that belong to the multi-level business infrastructure.

According to an embodiment of the invention, the additional information includes a first type of information representing a characteristic of high level business entities. Thus, stage 710 can resemble stage 310.

According to another embodiment of the invention, the additional information comprises intrinsic importance of multiple business entities. Thus, stage 710 can resemble stage 110.

Stage 710 is followed by stage 720 of calculating, in response to the received information, an importance of each of the multiple business entities; whereas an importance of a business entity represents a product resulting from utilizing the business entity.

According to an embodiment of the invention, stage 720 includes utilizing a probability based mathematical model of the multi-level business infrastructure.

According to another embodiment of the invention stage 720 includes calculating an importance of intermediate level and low level business entities.

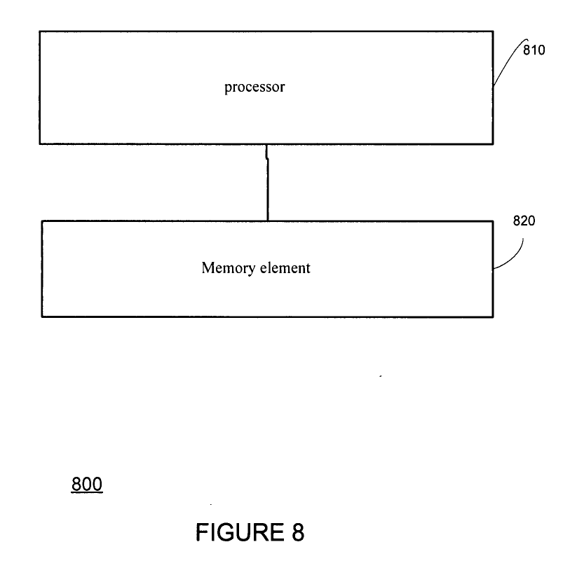

FIG. 8 illustrates a device 800, according to an embodiment of the invention. Conveniently, device 800 can execute one or more of methods 100, 200, and 700.

Device 800 include one or more memory elements, one or more processors, I/O ports, network adaptors or can be connected to such I/P ports or network adaptors.

For convenience of explanation FIG. 8 illustrates a single memory element 810 and a single processor 820 that are connected via a single bus. Those of skill in the art will appreciate that device 800 can have various configurations within the scope of the invention.

The memory element 810 is adapted to receive dependency information representative of dependencies between multiple business entities that form a multi-level business infrastructure. The memory element 810 is further adapted to receive additional information representative of at least one characteristic of at least two business entities that belong to the multi-level business infrastructure. Conveniently, the additional information includes intrinsic importance of multiple business entities. Conveniently, the additional information includes a first type of information representing a characteristic of high level business entities.

Processor 820 is adapted to calculate, in response to the received information, an importance of each of the multiple business entities; whereas an importance of a business entity can represent a product resulting from utilizing the business entity, a criticality of the business entity and the like.

Conveniently, processor 820 is adapted to utilize a probability based mathematical model of the multi-level business infrastructure. Conveniently, processor 820 is adapted to calculate an importance of intermediate level and low level business entities. Conveniently, processor 820 is adapted to convert a received first type of information to importance information of high level business entities.

Device 800 can be a part of the business infrastructure, can be located in proximate to the business infrastructure or be located in a remote location and not be included within the business infrastructure.

Variations, modifications, and other implementations of what is described herein will occur to those of ordinary skill in the art without departing from the spirit and the scope of the invention as claimed. Accordingly, the invention is to be defined not by the preceding illustrative description but instead by the spirit and scope of the following claims.

We claim:

1. A method for calculating an importance of multiple business entities, the method comprising:
receiving dependency information representative of dependencies between multiple business entities; and
utilizing a probability based mathematical model of a business infrastructure for determining the importance of multiple business entities.

2. The method according to claim 1 further comprising generating the probability based mathematical model.

3. The method according to claim 2 wherein the stage of generating comprises calculating inter-entity importance related probabilities.

4. The method according to claim 1 wherein the stage of utilizing comprises utilizing intrinsic probabilities.

5. The method according to claim 1 wherein the importance of a business entity represents a benefit resulting from a replacement or an update of the business entity.

6. The method according to claim 1 wherein the determining of an importance of a first business entity comprises multiplying an intrinsic importance of a dependency related business entity by an indication of an influence of a change in the dependency related business entity on the first business entity.

7. The method according to claim 1 further comprising selecting between multiple importance calculation mechanisms.

8. A method for calculating an importance of multiple business entities, the method comprising:
receiving dependency information representative of dependencies between business entities of a multi-level business infrastructure;
receiving a first type of information representing a characteristic of high level business entities;
converting the first type of information to importance information of the high level business entities; and
calculating an importance of intermediate level and low level business entities in response to the importance information of the high level business entities.

9. The method according to claim 8 wherein the stage of calculating comprises calculating an importance of all intermediate level business entities and all low level business entities that belong to the multi-level business infrastructure.

10. The method according to claim 8 wherein the importance of a business entity represents a benefit resulting from a replacement or an update of the business entity.

11. The method according to claim 8 wherein calculating an importance of a business entity that belongs to a certain level of the multi-level business infrastructure is preceded by calculating the importance of business entities that belong to a higher level of the multi-level business infrastructure.

12. The method according to claim 8 wherein the first type of information represents a relationship between a change of a high level business entity and a resulting change in a higher level business entity.

13. The method according to claim 8 wherein calculating an importance of a certain business entity comprises calculating an importance of at least one immediate business entity predecessor that depends upon the certain business entity.

14. The method according to claim 8 further comprising locating important business entities based upon the importance of the multiple business entities.

15. The method according to claim 8 wherein the high level business entities comprise intangible business entities.

16. A device, comprising:
a memory element adapted to receive dependency information representative of dependencies between multiple business entities that form a multi-level business infrastructure; and to receive additional information representative of at least one characteristic of at least two business entities that belong to the multi-level business infrastructure; and
a processor, coupled to the memory element, the processor is adapted to calculate, in response to the received information, an importance of each of the multiple business entities; whereas an importance of a business entity represents a product resulting from utilizing the business entity.

17. The device according to claim 16 wherein the processor is adapted to utilize a probability based mathematical model of the multi-level business infrastructure.

18. The device according to claim 16 wherein the processor is adapted to calculate an importance of intermediate level and low level business entities.

19. The device according to claim 16 wherein the processor is adapted to convert a received first type of information to importance information of high level business entities.

20. The device according to claim 16 wherein the additional information comprises intrinsic importance of multiple business entities.

21. The device according to claim 16 wherein the additional information comprises a first type of information representing a characteristic of high level business entities.

22. A computer program product comprising a computer useable medium including a computer readable program, wherein the computer readable program when executed on a computer causes the computer to:
receive dependency information representative of dependencies between multiple business entities; and
utilize a probability based mathematical model of a business infrastructure for determining the importance of multiple business entities.

23. The computer program product of claim 22 wherein the computer readable program when executed on a computer further causes the computer to generate the probability based mathematical model.

24. The computer program product of claim 22 wherein the computer readable program when executed on a computer further causes the computer to calculate inter-entity importance related probabilities.

25. The computer program product of claim 22 wherein the computer readable program when executed on a computer further causes the computer to utilize intrinsic probabilities.

26. The computer program product of claim 22 wherein the importance of a business entity represents a benefit resulting from a replacement or an update of the business entity.

27. The computer program product of claim 22 wherein the computer readable program when executed on a computer further causes the computer to multiply an intrinsic importance of a dependency related business entity by an indication of an influence of a change in the dependency related business entity on the first business entity.

28. A computer program product comprising a computer useable medium including a computer readable program, wherein the computer readable program when executed on a computer causes the computer to:
receive dependency information representative of dependencies between business entities of a multi-level business infrastructure;
receive a first type of information representing a characteristic of high level business entities;
convert the first type of information to importance information of the high level business entities; and
calculate an importance of intermediate level and low level business entities in response to the importance information of the high level business entities.

29. The computer program product of claim 28 wherein the computer readable program when executed on a computer further causes the computer to calculate an importance of all intermediate level business entities and all low level business entities that belong to the multi-level business infrastructure.

30. The computer program product of claim 28 wherein the importance of a business entity represents a benefit resulting from a replacement or an update of the business entity.

31. The computer program product of claim 28 wherein the computer readable program when executed on a computer further causes the computer to calculate an importance of a business entity that belongs to a certain level of the multi-level business infrastructure after a calculation of an importance of business entities that belong to a higher level of the multi-level business infrastructure.

32. The computer program product of claim 28 wherein the first type of information represents a relationship between a change of a high level business entity and a resulting change in a higher level business entity.

33. The computer program product of claim 28 wherein the computer readable program when executed on a computer further causes the computer to calculate an importance of at least one immediate business entity predecessor that depends upon the certain business entity.

34. The computer program product of claim 28 wherein the computer readable program when executed on a computer further causes the computer to locate important business entities based upon the importance of the multiple business entities.
